(19) United States
(12) Patent Application Publication
(10) Pub. No.: US 2026/0323489 A1
(43) Pub. Date: Oct. 15, 2026

(54) SYSTEMS AND METHODS FOR DYNAMIC NETWORK FUNCTION DISCOVERY IN A WIRELESS NETWORK

(71) Applicant: Verizon Patent and Licensing Inc., Basking Ridge, NJ (US)

(72) Inventors: Emerando M. Delos Reyes, Pleasant Hill, CA (US); Jerry Steben, Forth Worth, TX (US); Nitul Mehta, Nashua, NH (US); Michael Kondratiuk, Hillsborough, NJ (US)

(73) Assignee: Verizon Patent and Licensing Inc., Basking Ridge, NJ (US)

(21) Appl. No.: 19/178,100

(22) Filed: Apr. 14, 2025

(51) Int. Cl. H04W 48/16; H04W 76/18

(52) U.S. Cl. CPC H04W 48/16; H04W 76/18

(57) ABSTRACT

A device may maintain a set of discovery retry parameters associated with a Network Function ("NF") of a wireless network. The device may receive a discovery request that is associated with the NF, and determine, based on receiving the discovery request, that an operational state of the NF is a first operational state out of a plurality of operational states, such as an unavailable state. The device may identify that the set of discovery retry parameters indicates a quantity of discovery attempts to perform when determining that the NF is in the first operational state. The device may perform one or more discovery retry attempts based on the set of discovery retry parameters.

### BACKGROUND

Wireless networks provide wireless connectivity to User Equipment ("UEs"), such as mobile telephones, tablets, Internet of Things ("IoT") devices, Machine-to-Machine ("M2M") devices, or the like. Wireless networks may include or may be implemented by Network Functions ("NFs") that perform various operations relating to different respective functionalities of the wireless network. For example, different NFs may communicate with each other to perform operations such as establishing communication sessions between UEs and the wireless network, enforcing policies (e.g., network operator policies) with respect to different UEs or traffic types, authenticating UE authentication credentials, or the like. Some wireless networks may implement a virtualized or containerized deployment of NFs, such that the same NF or type of NF may be deployed as multiple instances. When different NFs of the wireless network communicates with each other, respective instances of the different NFs may communicate with each other.

### BRIEF DESCRIPTION OF THE DRAWINGS

FIG. 1 illustrates an example overview of one or more embodiments described herein;

FIG. 2 illustrates an example of different sets of discovery retry parameters in accordance with some embodiments;

FIG. 3 illustrates an example set of discovery retry parameters in accordance with some embodiments;

FIGS. 4A-4C illustrate an example of implementing a set of discovery retry parameters in accordance with some embodiments;

FIG. 5 illustrates an example of an NF instance performing a reconfiguration based on identifying that the NF instance is a backup indicated in one or more sets of discovery retry parameters, in accordance with some embodiments;

FIGS. 6 and 7 illustrate examples of modifying or refining discovery retry parameters, in accordance with some embodiments;

FIG. 8 illustrates an example process for implementing a set of discovery retry parameters in a wireless network, in accordance with some embodiments;

FIGS. 9 and 10 illustrate example environments in which one or more embodiments, described herein, may be implemented;

FIG. 11 illustrates an example arrangement of a radio access network ("RAN"), in accordance with some embodiments; and

FIG. 12 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

In a wireless network, different NFs may perform different operations relating to ultimately providing connectivity via the wireless network. In a wireless network in which NFs are deployed in a containerized or virtualized manner (e.g., as Cloud-Native Network Function ("CNFs"), Virtualized Network Functions ("VNFs"), or other similar terminology), particular respective NF instances may communicate with each other in order to implement their respective functionalities. For example, instances of different NFs that are associated with a first network slice may be configured to communicate with each other, and instances of different NFs that are associated with a second network slice may be configured to communicate with each other.

In an example situation in which an instance of a first NF determines that a communication should be sent to a second NF, the first NF may issue a discovery request associated with the second NF, which may include a request availability information, performance information, and/or other information associated with an instance of the second NF (herein referred to as "availability and/or performance information" for the sake of brevity). For example, the first NF may issue the discovery request to a network information repository of the wireless network, such as a Network Repository Function ("NRF"). The NRF may maintain availability and/or performance information, routing and/or topology information, communication information, and/or other information associated with respective instances of different NFs of the network.

The first NF may determine whether to proceed with communicating with the instance of the second NF based on the received availability and/or performance information. For example, the first NF may proceed with communicating with the instance of the second NF when the received availability and/or performance information indicates that the instance of the second NF is in an "available" state, is not in an "unavailable" state, and/or is operating within normal parameters. As another example, the first NF may proceed with communicating with the instance of the second NF when the availability and/or performance information indicates that performance and/or load metrics are above one or more thresholds (e.g., above a threshold measure of throughput, below a threshold measure of latency, below a threshold measure of load, or the like).

In some scenarios, a discovery request to the NRF may result in an error code or other type of indication of one or more errors, such as unavailability or unreachability errors (e.g., in which a given NF instance is unavailable or non-responsive), hardware failure errors, congestion errors, timeout errors, or the like. The NRF may, for example, receive a discovery request pertaining to an instance of a particular NF, and may communicate (or attempt to communicate) with the particular instance in order to determine whether the instance of the particular NF is available. Additionally, or alternatively, the NRF may monitor availability information associated with one or more NF instances, and/or may receive availability information associated with one or more NF instances from some other suitable device or system. In situations where the NRF determines that a particular NF instance (e.g., a particular NF instance indicated in a discovery request) is unavailable, the NRF may respond to the discovery request with an error code, indicating that the particular NF instance was unreachable. The issuer of the discovery request (e.g., another NF) may then need to issue subsequent discovery requests to the NRF, in order to identify when the particular NF instance becomes available.

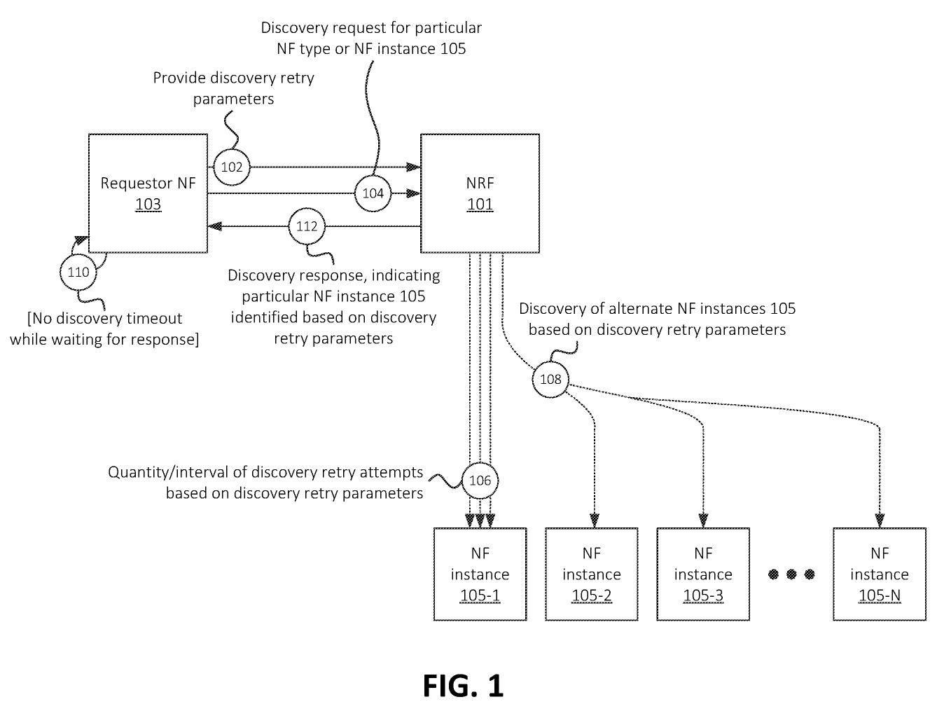

Embodiments described herein provide for a dynamic discovery retry mechanism, in which the NRF is able to handle error conditions related to discovery requests in a more efficient and configurable manner. For example, as shown in FIG. 1, NRF 101 may receive (at 102) a set of discovery retry parameters from a particular NF (e.g., referred to as requestor NF 103). For example, requestor NF 103 may register with NRF 101, and registering with NRF 101 may include providing the discovery retry parameters. As another example, a provisioning system or management platform of the wireless network may provide the discovery retry parameters. The discovery retry parameters may include parameters such as a particular quantity of times NRF should retry or reattempt to communicate with a respective NF instance 105 if such NF instance 105 is unavailable, an interval or duration of time to wait in between retry attempts, alternate or backup NF instances 105, and/or other suitable parameters.

At some subsequent point in time, NRF 101 may receive (at 104) a discovery request from requestor NF 103. The discovery request may include a request for communication information, availability and/or performance information, and/or other information associated with particular NF, a particular type of NF, and/or particular NF instance 105 (e.g., NF instance 105-1, NF instance 105-2, NF instance 105-3, NF instance 105-N, etc.). In one example, requestor NF 103 may be an Access and Mobility Management Function ("AMF") requesting discovery information for a Session Management Function ("SMF"). In other examples, requestor NF 103 and/or NF instance 105 may be different types of NFs (e.g., other than an AMF and/or an SMF).

In this example, assume that the discovery request includes a request for availability and/or performance information associated with NF instance 105-1, and/or that NRF 101 otherwise identifies that the discovery request is associated with NF instance 105-1. Further assume that the discovery retry parameters indicate that two retry attempts should be made to NF instance 105-1 if NF instance 105-1 is found to be unavailable or unreachable. In some embodiments, the discovery retry parameters may specify a particular retry interval, which may include an amount or duration of time that should elapse in between retry attempts.

Additionally, in this example, assume that the discovery retry parameters specify one or more other NF instances 105 as backups in the event that NF instance 105-1 is found to be unavailable or unreachable after three total attempts (e.g., an initial attempt and two retry attempts). Accordingly, situations such as the one shown in FIG. 1 may occur in which NRF 101 makes (at 106) the maximum quantity of discovery retry attempts specified in the discovery retry parameters (e.g., three total attempts). NRF 101 may proceed to attempt (at 108) to identify alternate or backup NF instances 105 (e.g., such as NF instances 105-2, 105-3, and/or 105-N, which may be instances of the same type of NF as NF instance 105-1). For example, NRF 101 may determine whether NF instance 105-2 is available or reachable, whether NF instance 105-3 is available or reachable, and so on.

In some embodiments, while NRF 101 performs discovery of NF instances 105 based on the discovery request, requestor NF 103 may forgo (at 110) identifying a timeout while awaiting a response from NRF 101. For example, requestor NF 103 may be "aware" that NRF 101 may potentially take longer to respond to the discovery request than a default or standard timeout value, inasmuch as requestor NF 103 may be "aware" that NRF 101 has received discovery retry parameters indicating an enhanced discovery retry procedure, as discussed herein. In the event that NRF 101 discovers or otherwise determines that a particular NF instance 105 is available, NRF 101 may respond (at 112) to the discovery request, indicating a particular NF instance 105 that has been identified. For example, in the event that NF instance 105-1 is found to be unavailable after three attempts, NRF 101 may have identified that NF instance 105-2 is available, and the response (at 112) may accordingly include discovery information (e.g., availability and/or performance information, communication information, etc.) associated with NF instance 105-2.

In this manner, discovery procedures in a wireless network may be more dynamic and robust, and may require less communication overhead between requestor NF 103 and NRF 101. That is, in situations where a requested NF instance 105 is unavailable or unreachable, embodiments described herein provide for a configurable error handling procedure that does not require additional communications between requestor NF 103 and NRF 101, thus ultimately reducing latency and communication disruptions that would otherwise be caused by the need for requestor NF 103 to repeatedly communicate with NRF 101 in order to perform a discovery procedure with respect to one or more NF instances 105.

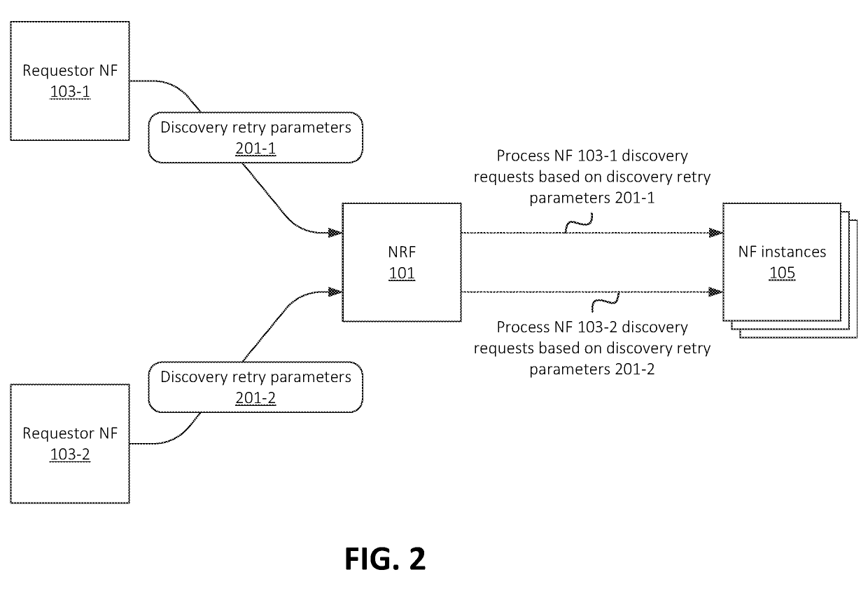

In some embodiments, as shown in FIG. 2, different discovery retry parameters 201 may be applicable to different requestor NFs 103. For example, requestor NF 103-1 may provide discovery retry parameters 201-1 to NRF 101 (and/or NRF 101 may otherwise receive discovery retry parameters 201-1 associated with requestor NF 103-1), and NRF 101 may also receive discovery retry parameters 201-2 associated with requestor NF 103-2. As such, different requestor NFs 103 may be associated with different discovery retry parameters 201, such as different quantities or intervals of retry attempts for different respective NF instances 105, different backup NF instances 105 for respective NF instances 105, etc. Thus, when processing discovery requests (e.g., performing discovery procedures based on discovery requests) from requestor NF 103-1, NRF 101 may perform such processing based on discovery retry parameters 201-1. Similarly, when processing discovery requests (e.g., performing discovery procedures based on discovery requests) from requestor NF 103-2, NRF 101 may perform such processing based on discovery retry parameters 201-2.

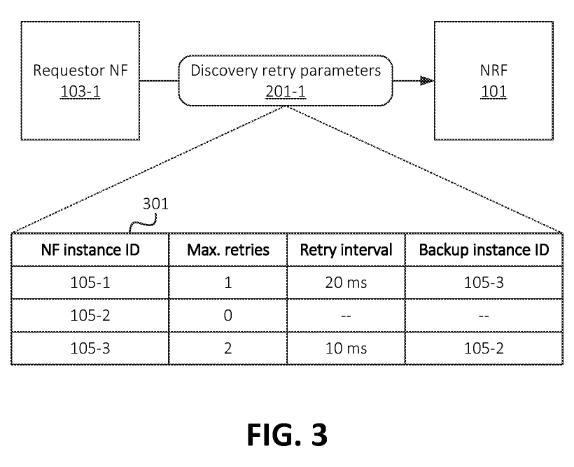

FIG. 3 illustrates example data structure 301, which may represent discovery retry parameters 201-1. In this example, discovery retry parameters 201-1 may include different parameters for different particular NF instances 105 (e.g., NF instances 105-1, 105-2, and 105-3). Data structure 301 may include, for each NF instance 105, a quantity of maximum retries, a retry interval, and a backup NF instance 105. For NF instance 105-1, for example, data structure 301 (e.g., discovery retry parameters 201-1) may specify that one retry attempt should be made if NF instance 105-1 is found to be unavailable, and that the retry attempt should occur 20 milliseconds (e.g., at least 20 milliseconds, exactly 20 milliseconds, etc.) after the initial attempt to discover, reach, or communicate with NF instance 105-1. Data structure 301 may further indicate that NF instance 105-3 is a backup of NF instance 105-1 (e.g., that NRF 101 should attempt to discover NF instance 105-3 if two attempts to discover NF instance 105-1 are unsuccessful).

Data structure 301 may additionally indicate that NF instance 105-2 is not associated with any retry attempts (e.g., only one attempt should be made to discover NF instance 105-2), and that no NF instances 105 are backups for NF instance 105-2. Data structure 301 may also indicate that NF instance 105-3 is associated with two retries (e.g., two maximum retries) with an interval of 10 milliseconds, and that NF instance 105-2 is a backup of NF instance 105-3.

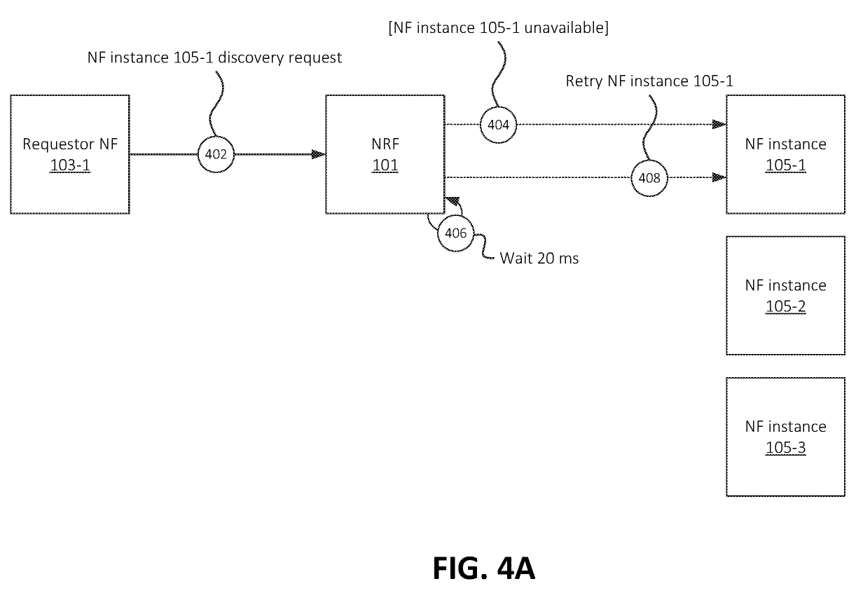

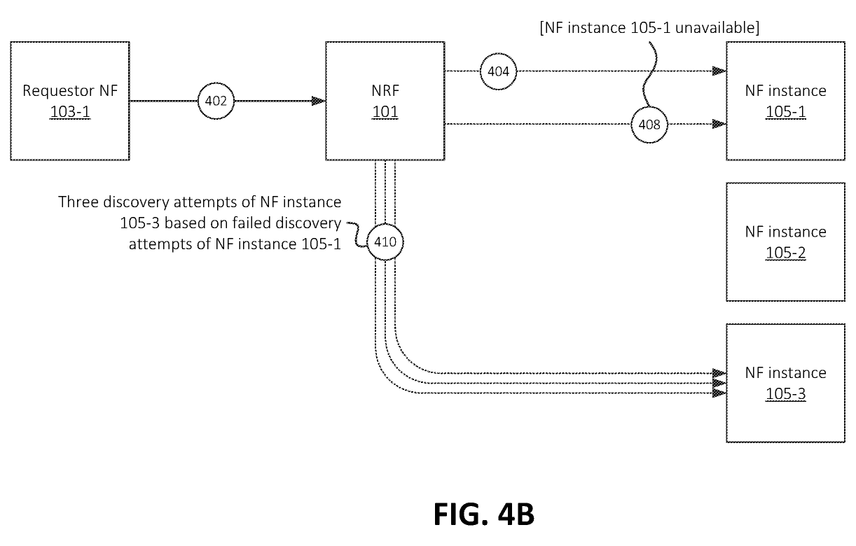

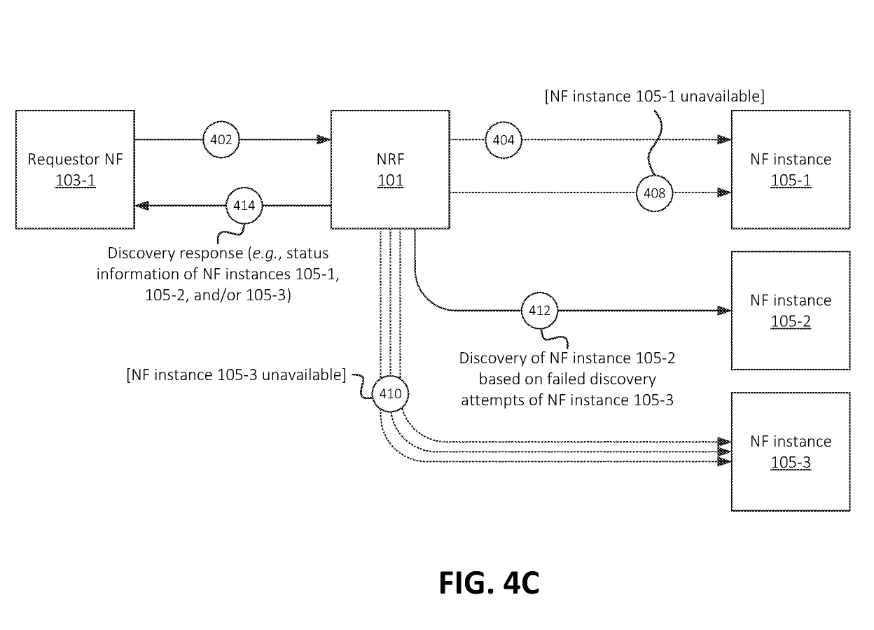

FIGS. 4A-4C illustrate an example scenario in which discovery retry parameters 201-1 are implemented (e.g., in response to a discovery request from requestor NF 103-1). For example, as shown in FIG. 4A, NRF 101 may receive (at 402) a discover request from requestor NF 103-1, which indicates that discovery information (e.g., availability and/or performance information, communication information, etc.) associated with NF instance 105-1 is being requested. NRF 101 may, accordingly, attempt (at 404) to discover, communicate with, reach, contact, etc. NF instance 105-1, and may determine that NF instance 105-1 is unavailable, unreachable, non-responsive (e.g., has not responded within a timeout threshold duration), etc. NRF 101 may accordingly wait (at 406) 20 milliseconds, which is the timeout interval specified in discovery retry parameters 201-1 associated with requestor NF 103-1 (e.g., as shown in data structure 301). After the timeout interval has elapsed, NRF 101 may retry (at 408) communicating with, reaching, etc. NF instance 105-1. As shown in FIG. 4B, this second attempt (at 408) may also be unsuccessful, and NF instance 105-1 may be identified as unavailable, unreachable, etc. a second time.

Since the maximum quantities of retries have occurred, NRF 101 may attempt (at 410) to reach, communicate with, etc. the backup NF instance 105 specified by discovery retry parameters 201-1, which is NF instance 105-3 in this example. In the scenario illustrated in FIG. 4B, assume that NRF 101 unsuccessfully performs (at 410) three discovery attempts with NF instance 105-3. For example, NRF 101 may make an initial attempt to reach NF instance 105-3, as well as the maximum quantity of discovery retry attempts (i.e., two attempts, in this example). As shown in FIG. 4C, the attempts to reach NF instance 105-3 may be unsuccessful (e.g., NF instance 105-3 may be unavailable or unreachable), and NRF 101 may accordingly identify that NF instance 105-2 has been specified as a backup NF instance for NF instance 105-3. NRF 101 may accordingly perform (at 412) discovery of NF instance 105-2 based on the failed discovery attempts of NF instance 105-3. In this example, assume that NRF 101 was able to successfully discover, reach, contact, communicate with, etc. (at 412) NF instance 105-2.

NRF 101 may accordingly provide (at 414) a discovery response to requestor NF 103-1 (e.g., in response to the discovery request at 402), indicating that NF instance 105-2 was found to be discoverable. In some embodiments, the discovery response may include an indication that NF instances 105-1 and 105-3 were not reachable, not discoverable, not available, etc. In some embodiments, the discovery response may include status information or other information associated with NF instances 105-1, 105-2, and/or 105-3. Such information may include, for example, load information, performance information, and/or other suitable information.

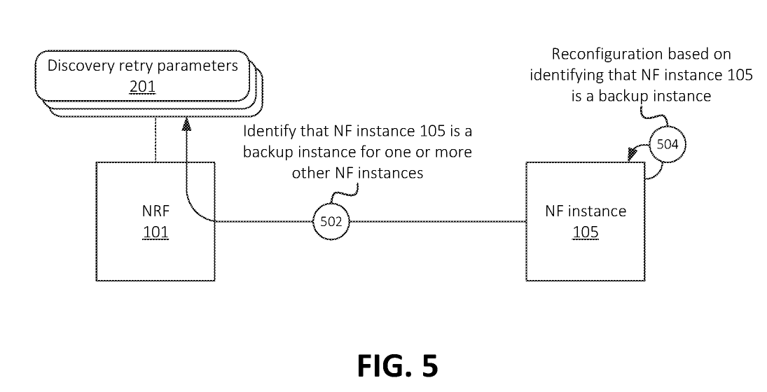

In some embodiments, as shown in FIG. 5, one or more respective NF instances 105 may identify (at 502) that such NF instances 105 have been specified as a backup instance (e.g., in one or more sets of discovery retry parameters 201) for one or more other NF instances 105. NF instance 105 may, accordingly, perform (at 504) one or more reconfiguration operations, such as allocating or provisioning additional resources, modifying priorities or queue weights, or other suitable reconfiguration operations. Such reconfiguration operations may be performed, for example, in order to accommodate potential additional load that may result from being assigned to communicate with respective requestor NFs 103 (e.g., based on NF instance 105 being discovered as an NF instance with which one or more requestor NFs 103 should communicate).

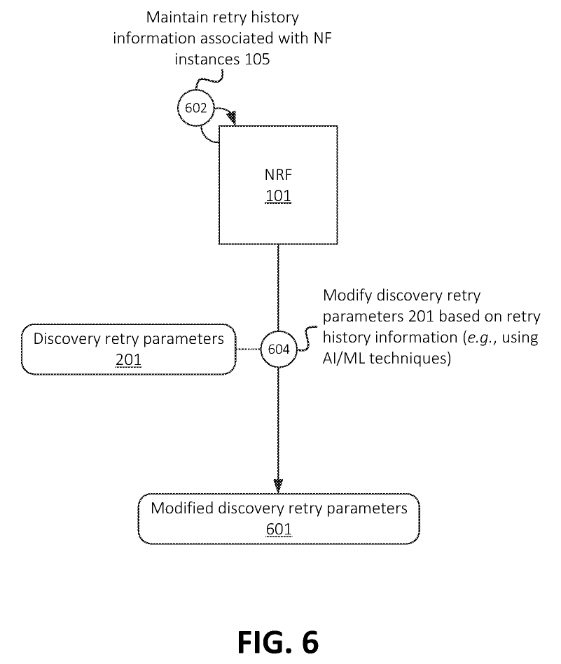

In some embodiments, as shown in FIG. 6, NRF 101 may maintain (at 602) retry history information and/or other suitable information associated with one or more NF instances 105. Such information may include, for example, a quantity of times that successful or unsuccessful retry attempts were made with respect to a particular NF instance 105, an amount of time between an initial unsuccessful discovery attempt and a successful discovery attempt with respect to the particular NF instance 105, and/or other suitable information associated with discovery operations with respect to the particular NF instance 105. In some embodiments, NRF 101 may modify (at 604) a particular set of discovery retry parameters 201 (e.g., using artificial intelligence/machine learning ("AI/ML") techniques or other suitable automated techniques) based on the retry history information and one or more models, optimization parameters, etc. For example, NRF 101 may increase a retry interval for a given NF instance 105 if the retry history interval indicates a relatively long duration of time between an initial unsuccessful discovery attempt and a successful discovery attempt with respect to NF instance 105. As another example, NRF 101 may add or modify the designation of a backup NF instance for a particular NF instance 105 (e.g., may select a backup NF instance with a relatively high measure of reliability, reachability, etc.). The modified set of discovery retry parameters 201 may be represented as modified discovery retry parameters 601.

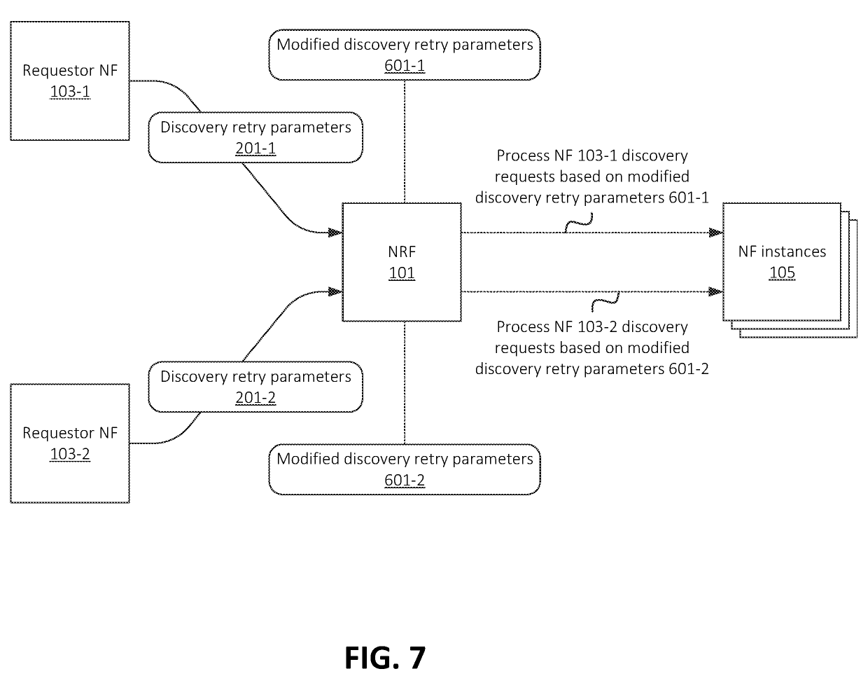

As similarly discussed above with respect to FIG. 2, and as shown in FIG. 7, different requestor NFs 103 may be associated with different discovery retry parameters 201 and/or modified discovery retry parameters 601. For example, NRF 101 may perform AI/ML techniques or other suitable techniques to generate modified discovery retry parameters 601-1 based on discovery retry parameters 201-1, and to generate modified discovery retry parameters 601-2 based on discovery retry parameters 201-2. Thus, when processing discovery requests associated with requestor NF 103-1, NRF 101 may process such requests using modified discovery retry parameters 601-1. Similarly, when processing discovery requests associated with requestor NF 103-2, NRF 101 may process such requests using modified discovery retry parameters 601-2.

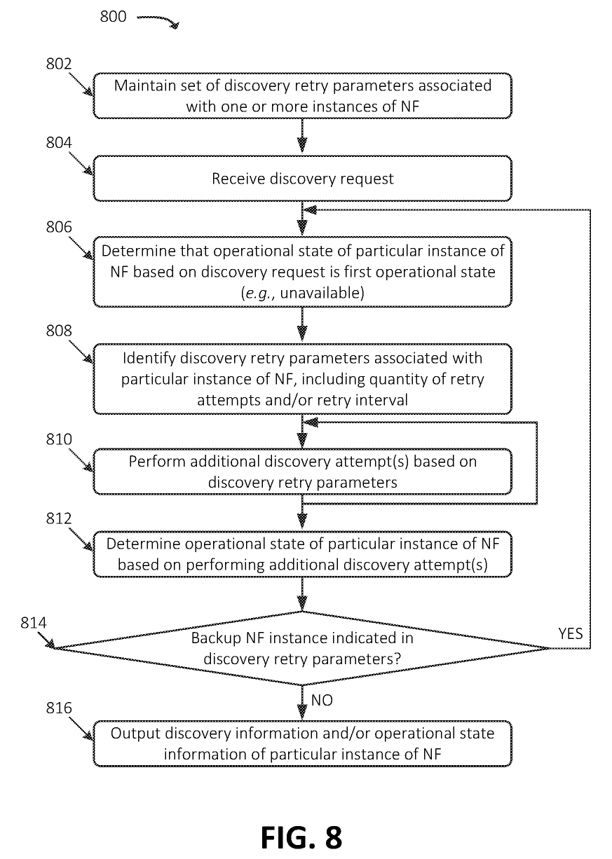

FIG. 8 illustrates an example process 800 for implementing a set of discovery retry parameters in a wireless network. In some embodiments, some or all of process 800 may be performed by NRF 101 and/or some other suitable device, system, or NF of the wireless network.

As shown, process 800 may include maintaining (at 802) a set of discovery retry parameters. For example, as discussed above, NRF 101 may receive or maintain different sets of discovery retry parameters 201 that are associated with different requestor NFs 103. Discovery retry parameters 201 may specify, for example, a quantity of retry attempts to perform when attempting to discover, communicate with, etc. one or more respective NF instances 105. As discussed above, discovery retry parameters 201 may also specify a retry interval, and/or one or more backup NF instances 105 (e.g., where such backup NF instances 105 may be the subject of subsequent discovery attempts if a given NF instance 105 is not reachable after performing a threshold quantity of discovery attempts).

Process 800 may further include receiving (at 804) a discovery request. For example, NRF 101 may receive the discovery request from a particular requestor NF 103. NRF 101 may identify that the discovery request is associated with a particular NF instance 105. For example, the discovery request may include an identifier of the particular NF instance 105. Additionally, or alternatively, the discovery request may include one or more parameters, conditions, criteria, etc. (e.g., geographical location, network slice, domain, Internet Protocol ("IP") range, NF type, etc.), based on which NRF 101 may identify the particular NF instance 105 (e.g., the particular NF instance 105 may meet the parameters, conditions, criteria, etc.). The discovery request may include a request for operational status of the particular NF instance 105, such as reachable, operational, available, unreachable, non-operational, unavailable, etc. Additionally, or alternatively, the discovery request may include a request for availability and/or performance information associated with NF instance 105, and/or other types of information associated with NF instance 105.

Process 800 may additionally include determining (at 806) that the operational state of the particular NF instance 105 is a first operational state (e.g., an unavailable state, an unreachable state, a congested state, etc.) based on the discovery request. For example, after receiving the discovery request, NRF 101 may communicate with (or attempt to communicate with) the particular NF instance 105 to determine the operational state of NF instance 105. Additionally, or alternatively, NRF 101 may obtain or receive operational state information, associated with NF instance 105, from some other suitable source.

Process 800 may also include identifying (at 808) that the discovery retry parameters indicate a particular quantity of discovery retry attempts to perform, with respect to the particular NF instance, when the particular NF instance is in the first operational state (e.g., when the particular NF instance is in an unreachable operational state, an error operational state, an unavailable operational state, etc.). Additionally, or alternatively, the discovery retry parameters may indicate a particular retry interval that specifies a duration of time between such retry attempts.

Process 800 may further include performing (at 810) one or more additional discovery retry attempts based on the discovery retry attempts. For example, NRF 101 may perform up to (e.g., equal to or fewer than) a total amount of discovery retry attempts specified in the discovery retry parameters. For example, in situations where NRF 101 identifies that the particular NF instance 105 is in a second operational state (e.g., a reachable operational state, an available operational state, an uncongested operational state, a nominal operational state, etc.), NRF 101 may forgo performing any further discovery attempts, and may determine (at 812) that the particular NF instance 105 is in the second operational state.

On the other hand, if NRF 101 determines that the particular NF instance 105 is still in the first operational state (e.g., after performing the maximum quantity of discovery retry attempts specified by the discovery retry parameters), NRF 101 may determine (at 814) whether any backup NF instances 105 are specified in the discovery retry parameters. If a backup NF instance 105 is specified in the discovery retry parameters, NRF 101 may perform some or all of the above operations with respect to the backup NF instance 105, as discussed above.

Process 800 may further include outputting (at 816) discovery information and/or operational state information associated with the particular NF instance 105 (e.g., as specified in the discovery request, and/or as identified being a backup NF instance 105 for the particular NF instance 105). For example, NRF 101 may indicate whether the particular NF instance 105 (or a backup NF instance 105) was able to be discovered, reached, communicated with, etc. In situations where NRF 101 was not able to discover, reach, communicate with, etc. a given NF instance 105, NRF 101 may output (at 816) one or more error codes and/or indications that NF instance 105 was in the first operational state (e.g., an unavailable or unreachable state). On the other hand, when NRF 101 is able to discover, reach, communicate with, etc. a given NF instance 105, NRF 101 may output discovery information associated with such NF instance 105, such as availability and/or performance information, communication information, one or more identifiers of NF instance 105, and/or other suitable information.

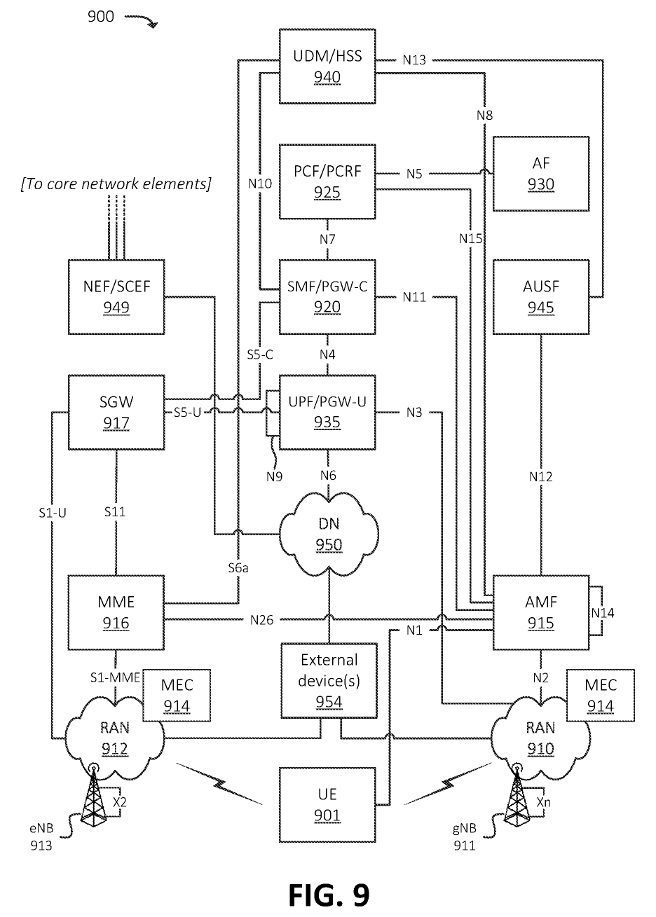

FIG. 9 illustrates an example environment 900, in which one or more embodiments may be implemented. In some embodiments, environment 900 may correspond to a Fifth Generation ("5G") network, and/or may include elements of a 5G network. In some embodiments, environment 900 may correspond to a 5G Non-Standalone ("NSA") architecture, in which a 5G radio access technology ("RAT") may be used in conjunction with one or more other RATs (e.g., a Long-Term Evolution ("LTE") RAT), and/or in which elements of a 5G core network may be implemented by, may be communicatively coupled with, and/or may include elements of another type of core network (e.g., an evolved packet core ("EPC")). In some embodiments, portions of environment 900 may represent or may include a 5G core ("5GC"). As shown, environment 900 may include UE 901, RAN 910 (which may include one or more Next Generation Node Bs ("gNBs") 911), RAN 912 (which may include one or more evolved Node Bs ("eNBs") 913), and various network functions such as Access and Mobility Management Function ("AMF") 915, Mobility Management Entity ("MME") 916, Serving Gateway ("SGW") 917, Session Management Function ("SMF")/Packet Data Network ("PDN") Gateway ("PGW")-Control plane function ("PGW-C") 920, Policy Control Function ("PCF")/Policy Charging and Rules Function ("PCRF") 925, Application Function ("AF") 930, User Plane Function ("UPF")/PGW-User plane function ("PGW-U") 935, Unified Data Management ("UDM")/Home Subscriber Server ("HSS") 940, Authentication Server Function ("AUSF") 945, and Network Exposure Function ("NEF")/Service Capability Exposure Function ("SCEF") 949. Environment 900 may also include one or more networks, such as Data Network ("DN") 950. Environment 900 may include one or more additional devices or systems communicatively coupled to one or more networks (e.g., DN 950), such as one or more external devices 954.

The example shown in FIG. 9 illustrates one instance of each network component or function (e.g., one instance of SMF/PGW-C 920, PCF/PCRF 925, UPF/PGW-U 935, UDM/HSS 940, and/or AUSF 945). In practice, environment 900 may include multiple instances of such components or functions. For example, in some embodiments, environment 900 may include multiple "slices" of a core network, where each slice includes a discrete and/or logical set of network functions (e.g., one slice may include a first instance of AMF 915, SMF/PGW-C 920, PCF/PCRF 925, and/or UPF/PGW-U 935, while another slice may include a second instance of AMF 915, SMF/PGW-C 920, PCF/PCRF 925, and/or UPF/PGW-U 935). The different slices may provide differentiated levels of service, such as service in accordance with different Quality of Service ("QoS") parameters.

The quantity of devices and/or networks, illustrated in FIG. 9, is provided for explanatory purposes only. In practice, environment 900 may include additional devices and/or networks, fewer devices and/or networks, different devices and/or networks, or differently arranged devices and/or networks than illustrated in FIG. 9. For example, while not shown, environment 900 may include devices that facilitate or enable communication between various components shown in environment 900, such as routers, modems, gateways, switches, hubs, etc. In some implementations, one or more devices of environment 900 may be physically integrated in, and/or may be physically attached to, one or more other devices of environment 900. Alternatively, or additionally, one or more of the devices of environment 900 may perform one or more network functions described as being performed by another one or more of the devices of environment 900.

Additionally, one or more elements of environment 900 may be implemented in a virtualized and/or containerized manner. For example, one or more of the elements of environment 900 may be implemented by one or more NFs, VNFs, CNFs, etc. As discussed above, such NFs, VNFs, CNFs, etc. may include one or more requestor NFs 103 and/or NF instances 105, which were included as examples in the description above.

In such embodiments, environment 900 may include, may implement, and/or may be communicatively coupled to an orchestration platform that provisions hardware resources, installs containers or applications, performs load balancing, and/or otherwise manages the deployment of such elements of environment 900. In some embodiments, such orchestration and/or management of such elements of environment 900 may be performed by, or in conjunction with, the open-source Kubernetes^{®} application programming interface ("API") or some other suitable virtualization, containerization, and/or orchestration system.

Elements of environment 900 may interconnect with each other and/or other devices via wired connections, wireless connections, or a combination of wired and wireless connections. Examples of interfaces or communication pathways between the elements of environment 900, as shown in FIG. 9, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 9, such as Service-Based Interfaces ("SBIs"), including an Namf interface, an Nudm interface, an Npcf interface, an Nupf interface, an Nnef interface, an Nsmf interface, and/or one or more other SBIs.

UE 901 may include a computation and communication device, such as a wireless mobile communication device that is capable of communicating with RAN 910, RAN 912, and/or DN 950. UE 901 may be, or may include, a radiotelephone, a personal communications system ("PCS") terminal (e.g., a device that combines a cellular radiotelephone with data processing and data communications capabilities), a personal digital assistant ("PDA") (e.g., a device that may include a radiotelephone, a pager, Internet/intranet access, etc.), a smart phone, a laptop computer, a tablet computer, a camera, a personal gaming system, an Internet of Things ("IoT") device (e.g., a sensor, a smart home appliance, a wearable device, a programmable logic controller or other industrial controller, a Machine-to-Machine ("M2M") device, or the like), a Fixed Wireless Access ("FWA") device, or another type of mobile computation and communication device. UE 901 may send traffic to and/or receive traffic (e.g., user plane traffic) from DN 950 via RAN 910, RAN 912, and/or UPF/PGW-U 935.

RAN 910 may be, or may include, a 5G RAN that implements a 5G RAT and that includes one or more base stations (e.g., one or more gNBs 911), via which UE 901 may communicate with one or more other elements of environment 900. UE 901 may communicate with RAN 910 via an air interface (e.g., as provided by gNB 911). For instance, RAN 910 may receive traffic (e.g., user plane traffic such as voice call traffic, data traffic, messaging traffic, etc.) from UE 901 via the air interface, and may communicate the traffic to UPF/PGW-U 935 and/or one or more other devices or networks. Further, RAN 910 may receive signaling traffic, control plane traffic, etc. from UE 901 via the air interface, and may communicate such signaling traffic, control plane traffic, etc. to AMF 915 and/or one or more other devices or networks. Additionally, RAN 910 may receive traffic intended for UE 901 (e.g., from UPF/PGW-U 935, AMF 915, and/or one or more other devices or networks) and may communicate the traffic to UE 901 via the air interface.

RAN 912 may be, or may include, an LTE RAN that implements an LTE RAT and that includes one or more base stations (e.g., one or more eNBs 913), via which UE 901 may communicate with one or more other elements of environment 900. UE 901 may communicate with RAN 912 via an air interface (e.g., as provided by eNB 913). For instance, RAN 912 may receive traffic (e.g., user plane traffic such as voice call traffic, data traffic, messaging traffic, signaling traffic, etc.) from UE 901 via the air interface, and may communicate the traffic to UPF/PGW-U 935 (e.g., via SGW 917) and/or one or more other devices or networks. Further, RAN 912 may receive signaling traffic, control plane traffic, etc. from UE 901 via the air interface, and may communicate such signaling traffic, control plane traffic, etc. to MME 916 and/or one or more other devices or networks. Additionally, RAN 912 may receive traffic intended for UE 901 (e.g., from UPF/PGW-U 935, MME 916, SGW 917, and/or one or more other devices or networks) and may communicate the traffic to UE 901 via the air interface.

One or more RANs of environment 900 (e.g., RAN 910 and/or RAN 912) may include, may implement, and/or may otherwise be communicatively coupled to one or more edge computing devices, such as one or more Multi-Access/Mobile Edge Computing ("MEC") devices (referred to sometimes herein simply as a "MECs") 914. MECs 914 may be co-located with wireless network infrastructure equipment of RANs 910 and/or 912 (e.g., one or more gNBs 911 and/or one or more eNBs 913, respectively). Additionally, or alternatively, MECs 914 may otherwise be associated with geographical regions (e.g., coverage areas) of wireless network infrastructure equipment of RANs 910 and/or 912. In some embodiments, one or more MECs 914 may be implemented by the same set of hardware resources, the same set of devices, etc. that implement wireless network infrastructure equipment of RANs 910 and/or 912. In some embodiments, one or more MECs 914 may be implemented by different hardware resources, a different set of devices, etc. from hardware resources or devices that implement wireless network infrastructure equipment of RANs 910 and/or 912. In some embodiments, MECs 914 may be communicatively coupled to wireless network infrastructure equipment of RANs 910 and/or 912 (e.g., via a high-speed and/or low-latency link such as a physical wired interface, a high-speed and/or low-latency wireless interface, or some other suitable communication pathway).

MECs 914 may include hardware resources (e.g., configurable or provisionable hardware resources) that may be configured to provide services and/or otherwise process traffic to and/or from UE 901, via RAN 910 and/or 912. For example, RAN 910 and/or 912 may route some traffic from UE 901 (e.g., traffic associated with one or more particular services, applications, application types, etc.) to a respective MEC 914 instead of to core network elements of 900 (e.g., UPF/PGW-U 935). MEC 914 may accordingly provide services to UE 901 by processing such traffic, performing one or more computations based on the received traffic, and providing traffic to UE 901 via RAN 910 and/or 912. MEC 914 may include, and/or may implement, some or all of the functionality described above with respect to UPF/PGW-U 935, AF 930, one or more application servers, and/or one or more other devices, systems, VNFs, CNFs, etc. In this manner, ultra-low latency services may be provided to UE 901, as traffic does not need to traverse links (e.g., backhaul links) between RAN 910 and/or 912 and the core network.

AMF 915 may include one or more devices, systems, VNFs, CNFs, etc., that perform operations to register UE 901 with the 5G network, to establish bearer channels associated with a session with UE 901, to hand off UE 901 from the 5G network to another network, to hand off UE 901 from the other network to the 5G network, manage mobility of UE 901 between RANs 910 and/or gNBs 911, and/or to perform other operations. In some embodiments, the 5G network may include multiple AMFs 915, which communicate with each other via the N14 interface (denoted in FIG. 9 by the line marked "N14" originating and terminating at AMF 915).

MME 916 may include one or more devices, systems, VNFs, CNFs, etc., that perform operations to register UE 901 with the EPC, to establish bearer channels associated with a session with UE 901, to hand off UE 901 from the EPC to another network, to hand off UE 901 from another network to the EPC, manage mobility of UE 901 between RANs 912 and/or eNBs 913, and/or to perform other operations.

SGW 917 may include one or more devices, systems, VNFs, CNFs, etc., that aggregate traffic received from one or more eNBs 913 and send the aggregated traffic to an external network or device via UPF/PGW-U 935. Additionally, SGW 917 may aggregate traffic received from one or more UPF/PGW-Us 935 and may send the aggregated traffic to one or more eNBs 913. SGW 917 may operate as an anchor for the user plane during inter-eNB handovers and as an anchor for mobility between different telecommunication networks or RANs (e.g., RANs 910 and 912).

SMF/PGW-C 920 may include one or more devices, systems, VNFs, CNFs, etc., that gather, process, store, and/or provide information in a manner described herein. SMF/PGW-C 920 may, for example, facilitate the establishment of communication sessions on behalf of UE 901. In some embodiments, the establishment of communications sessions may be performed in accordance with one or more policies provided by PCF/PCRF 925.

PCF/PCRF 925 may include one or more devices, systems, VNFs, CNFs, etc., that aggregate information to and from the 5G network and/or other sources. PCF/PCRF 925 may receive information regarding policies and/or subscriptions from one or more sources, such as subscriber databases and/or from one or more users (such as, for example, an administrator associated with PCF/PCRF 925).

AF 930 may include one or more devices, systems, VNFs, CNFs, etc., that receive, store, and/or provide information that may be used in determining parameters (e.g., quality of service parameters, charging parameters, or the like) for certain applications.

UPF/PGW-U 935 may include one or more devices, systems, VNFs, CNFs, etc., that receive, store, and/or provide data (e.g., user plane data). For example, UPF/PGW-U 935 may receive user plane data (e.g., voice call traffic, data traffic, etc.), destined for UE 901, from DN 950, and may forward the user plane data toward UE 901 (e.g., via RAN 910, SMF/PGW-C 920, and/or one or more other devices). In some embodiments, multiple instances of UPF/PGW-U 935 may be deployed (e.g., in different geographical locations), and the delivery of content to UE 901 may be coordinated via the N9 interface (e.g., as denoted in FIG. 9 by the line marked "N9" originating and terminating at UPF/PGW-U 935). Similarly, UPF/PGW-U 935 may receive traffic from UE 901 (e.g., via RAN 910, RAN 912, SMF/PGW-C 920, and/or one or more other devices), and may forward the traffic toward DN 950. In some embodiments, UPF/PGW-U 935 may communicate (e.g., via the N4 interface) with SMF/PGW-C 920, regarding user plane data processed by UPF/PGW-U 935.

UDM/HSS 940 and AUSF 945 may include one or more devices, systems, VNFs, CNFs, etc., that manage, update, and/or store, in one or more memory devices associated with AUSF 945 and/or UDM/HSS 940, profile information associated with a subscriber. In some embodiments, UDM/HSS 940 may include, may implement, may be communicatively coupled to, and/or may otherwise be associated with some other type of repository or database, such as a Unified Data Repository ("UDR"). AUSF 945 and/or UDM/HSS 940 may perform authentication, authorization, and/or accounting operations associated with one or more UEs 901 and/or one or more communication sessions associated with one or more UEs 901.

DN 950 may include one or more wired and/or wireless networks. For example, DN 950 may include an IP-based PDN, a wide area network ("WAN") such as the Internet, a private enterprise network, and/or one or more other networks. UE 901 may communicate, through DN 950, with data servers, other UEs 901, and/or to other servers or applications that are coupled to DN 950. DN 950 may be connected to one or more other networks, such as a public switched telephone network ("PSTN"), a public land mobile network ("PLMN"), and/or another network. DN 950 may be connected to one or more devices, such as content providers, applications, web servers, and/or other devices, with which UE 901 may communicate.

External devices 954 may include one or more devices or systems that communicate with UE 901 via DN 950 and one or more elements of 900 (e.g., via UPF/PGW-U 935). External devices 954 may include, for example, one or more application servers, content provider systems, web servers, or the like. External devices 954 may, for example, implement "server-side" applications that communicate with "client-side" applications executed by UE 901. External devices 954 may provide services to UE 901 such as gaming services, videoconferencing services, messaging services, email services, web services, and/or other types of services. Operations described above with respect to a given external device 954 (e.g., in accordance with some embodiments) may be performed by a single device, by a cloud computing system, by one or more devices that implement a virtualized or containerized environment, a collection of devices, etc.

In some embodiments, external devices 954 may communicate with one or more elements of environment 900 (e.g., core network elements) via NEF/SCEF 949. NEF/SCEF 949 include one or more devices, systems, VNFs, CNFs, etc. that provide access to information, APIs, and/or other operations or mechanisms of one or more core network elements to devices or systems that are external to the core network (e.g., to external device 954 via DN 950). NEF/SCEF 949 may maintain authorization and/or authentication information associated with such external devices or systems, such that NEF/SCEF 949 is able to provide information, that is authorized to be provided, to the external devices or systems. For example, a given external device 954 may request particular information associated with one or more core network elements. NEF/SCEF 949 may authenticate the request and/or otherwise verify that external device 954 is authorized to receive the information, and may request, obtain, or otherwise receive the information from the one or more core network elements. In some embodiments, NEF/SCEF 949 may include, may implement, may be implemented by, may be communicatively coupled to, and/or may otherwise be associated with a Security Edge Protection Proxy ("SEPP"), which may perform some or all of the functions discussed above. External device 954 may, in some situations, subscribe to particular types of requested information provided by the one or more core network elements, and the one or more core network elements may provide (e.g., "push") the requested information to NEF/SCEF 949 (e.g., in a periodic or otherwise ongoing basis).

In some embodiments, external devices 954 may communicate with one or more elements of RAN 910 and/or 912 via an API or other suitable interface. For example, a given external device 954 may provide instructions, requests, etc. to RAN 910 and/or 912 to provide one or more services via one or more respective MECs 914. In some embodiments, such instructions, requests, etc. may include QoS parameters, Service Level Agreements ("SLAs"), etc. (e.g., maximum latency thresholds, minimum throughput thresholds, etc.) associated with the services.

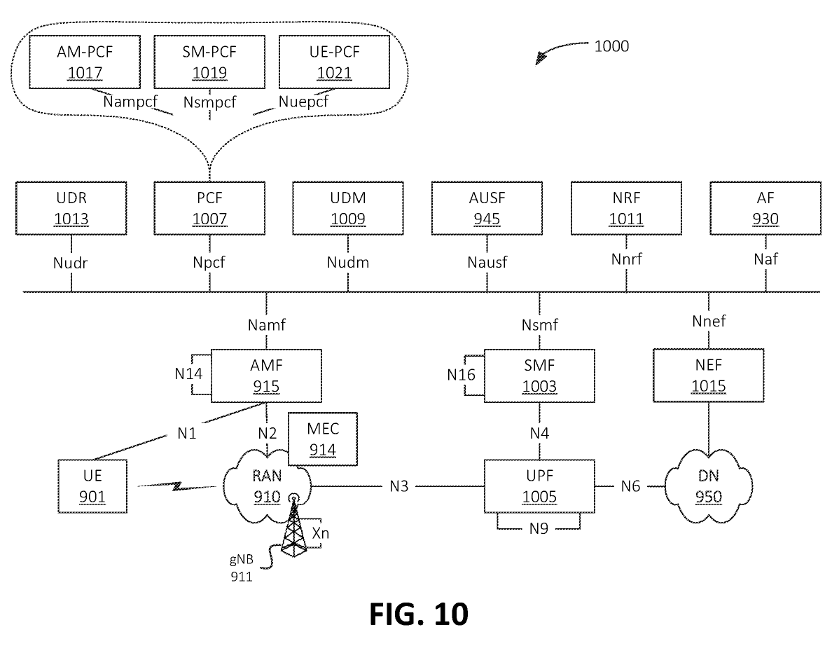

FIG. 10 illustrates another example environment 1000, in which one or more embodiments may be implemented. In some embodiments, environment 1000 may correspond to a 5G network, and/or may include elements of a 5G network. In some embodiments, environment 1000 may correspond to a 5G SA architecture. In some embodiments, environment 1000 may include a 5GC, in which 5GC network elements perform one or more operations described herein.

As shown, environment 1000 may include UE 901, RAN 910 (which may include one or more gNBs 911 or other types of wireless network infrastructure) and various network functions, which may be implemented as VNFs, CNFs, etc. Such network functions may include AMF 915, SMF 1003, UPF 1005, PCF 1007, UDM 1009, AUSF 945, Network Repository Function ("NRF") 1011, AF 930, UDR 1013, and NEF 1015. Environment 1000 may also include or may be communicatively coupled to one or more networks, such as DN 950.

The example shown in FIG. 10 illustrates one instance of each network component or function (e.g., one instance of SMF 1003, UPF 1005, PCF 1007, UDM 1009, AUSF 945, etc.). In practice, environment 1000 may include multiple instances of such components or functions. For example, in some embodiments, environment 1000 may include multiple "slices" of a core network, where each slice includes a discrete and/or logical set of network functions (e.g., one slice may include a first instance of SMF 1003, PCF 1007, UPF 1005, etc., while another slice may include a second instance of SMF 1003, PCF 1007, UPF 1005, etc.). Additionally, or alternatively, one or more of the network functions of environment 1000 may implement multiple network slices. The different slices may provide differentiated levels of service, such as service in accordance with different QoS parameters.

The quantity of devices and/or networks, illustrated in FIG. 10, is provided for explanatory purposes only. In practice, environment 1000 may include additional devices and/or networks, fewer devices and/or networks, different devices and/or networks, or differently arranged devices and/or networks than illustrated in FIG. 10. For example, while not shown, environment 1000 may include devices that facilitate or enable communication between various components shown in environment 1000, such as routers, modems, gateways, switches, hubs, etc. In some implementations, one or more devices of environment 1000 may be physically integrated in, and/or may be physically attached to, one or more other devices of environment 1000. Alternatively, or additionally, one or more of the devices of environment 1000 may perform one or more network functions described as being performed by another one or more of the devices of environment 1000.

Elements of environment 1000 may interconnect with each other and/or other devices via wired connections, wireless connections, or a combination of wired and wireless connections. Examples of interfaces or communication pathways between the elements of environment 1000, as shown in FIG. 10, may include interfaces shown in FIG. 10 and/or one or more interfaces not explicitly shown in FIG. 10. These interfaces may include interfaces between specific network functions, such as an N1 interface, an N2 interface, an N3 interface, an N6 interface, an N9 interface, an N14 interface, an N16 interface, and/or one or more other interfaces. In some embodiments, one or more elements of environment 1000 may communicate via a service-based architecture ("SBA"), in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 915), an Nudm interface (e.g., indicating communications to be routed to UDM 1009), an Npcf interface, an Nupf interface, an Nnef interface, an Nsmf interface, an Nnrf interface, an Nudr interface, an Naf interface, and/or one or more other SBIs.

UPF 1005 may include one or more devices, systems, VNFs, CNFs, etc., that receive, route, process, and/or forward traffic (e.g., user plane traffic). As discussed above, UPF 1005 may communicate with UE 901 via one or more communication sessions, such as PDU sessions. Such PDU sessions may be associated with a particular network slice or other suitable QoS parameters, as noted above. UPF 1005 may receive downlink user plane traffic (e.g., voice call traffic, data traffic, etc. destined for UE 901) from DN 950, and may forward the downlink user plane traffic toward UE 901 (e.g., via RAN 910). In some embodiments, multiple UPFs 1005 may be deployed (e.g., in different geographical locations), and the delivery of content to UE 901 may be coordinated via the N9 interface. Similarly, UPF 1005 may receive uplink traffic from UE 901 (e.g., via RAN 910), and may forward the traffic toward DN 950. In some embodiments, UPF 1005 may implement, may be implemented by, may be communicatively coupled to, and/or may otherwise be associated with UPF/PGW-U 935. In some embodiments, UPF 1005 may communicate (e.g., via the N4 interface) with SMF 1003, regarding user plane data processed by UPF 1005 (e.g., to provide analytics or reporting information, to receive policy and/or authorization information, etc.).

PCF 1007 may include one or more devices, systems, VNFs, CNFs, etc., that aggregate, derive, generate, etc. policy information associated with the 5GC and/or UEs 901 that communicate via the 5GC and/or RAN 910. PCF 1007 may receive information regarding policies and/or subscriptions from one or more sources, such as subscriber databases (e.g., UDM 1009, UDR 1013, etc.), and/or from one or more users such as, for example, an administrator associated with PCF 1007. In some embodiments, the functionality of PCF 1007 may be split into multiple network functions or subsystems, such as access and mobility PCF ("AM-PCF") 1017, session management PCF ("SM-PCF") 1019, UE PCF ("UE-PCF") 1021, and so on. Such different "split" PCFs may be associated with respective SBIs (e.g., AM-PCF 1017 may be associated with an Nampcf SBI, SM-PCF 1019 may be associated with an Nsmpcf SBI, UE-PCF 1021 may be associated with an Nuepcf SBI, and so on) via which other network functions may communicate with the split PCFs. The split PCFs may maintain information regarding policies associated with different devices, systems, and/or network functions.

NRF 1011 may include one or more devices, systems, VNFs, CNFs, etc. that maintain routing and/or network topology information associated with the 5GC. For example, NRF 1011 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 1013 may include one or more devices, systems, VNFs, CNFs, etc. that provide user and/or subscriber information, based on which PCF 1007 and/or other elements of environment 1000 may determine access policies, QoS policies, charging policies, or the like. In some embodiments, UDR 1013 may receive such information from UDM 1009 and/or one or more other sources.

NEF 1015 include one or more devices, systems, VNFs, CNFs, etc. that provide access to information, APIs, and/or other operations or mechanisms of the 5GC to devices or systems that are external to the 5GC. NEF 1015 may maintain authorization and/or authentication information associated with such external devices or systems, such that NEF 1015 is able to provide information, that is authorized to be provided, to the external devices or systems. Such information may be received from other network functions of the 5GC (e.g., as authorized by an administrator or other suitable entity associated with the 5GC), such as SMF 1003, UPF 1005, a charging function ("CHF") of the 5GC, and/or other suitable network function. NEF 1015 may communicate with external devices or systems (e.g., external devices 954) via DN 950 and/or other suitable communication pathways.

While environment 1000 is described in the context of a 5GC, as noted above, environment 1000 may, in some embodiments, include or implement one or more other types of core networks. For example, in some embodiments, environment 1000 may be or may include a converged packet core, in which one or more elements may perform some or all of the functionality of one or more 5GC network functions and/or one or more EPC network functions. For example, in some embodiments, AMF 915 may include, may implement, may be implemented by, and/or may otherwise be associated with MME 916; SMF 1003 may include, may implement, may be implemented by, and/or may otherwise be associated with SGW 917; PCF 1007 may include, may implement, may be implemented by, and/or may otherwise be associated with a PCRF (e.g., PCF/PCRF 925); NEF 1015 may include, may implement, may be implemented by, and/or may otherwise be associated with a SCEF (e.g., NEF/SCEF 949); and so on.

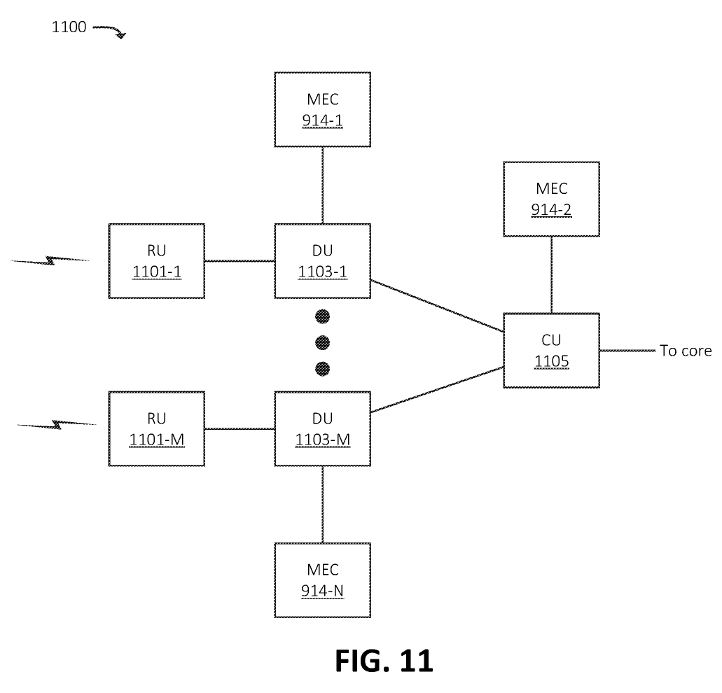

FIG. 11 illustrates an example RAN environment 1100, which may be included in and/or implemented by one or more RANs (e.g., RAN 910 or some other RAN). In some embodiments, a particular RAN 910 may include one RAN environment 1100. In some embodiments, a particular RAN 910 may include multiple RAN environments 1100. In some embodiments, RAN environment 1100 may correspond to a particular gNB 911 of RAN 910. In some embodiments, RAN environment 1100 may correspond to multiple gNBs 911. In some embodiments, RAN environment 1100 may correspond to one or more other types of base stations of one or more other types of RANs. As shown, RAN environment 1100 may include Central Unit ("CU") 1105, one or more Distributed Units ("DUs") 1103-1 through 1103-M (referred to individually as "DU 1103," or collectively as "DUs 1103"), and one or more Radio Units ("RUs") 1101-1 through 1101-M (referred to individually as "RU 1101," or collectively as "RUs 1101").

CU 1105 may communicate with a core of a wireless network (e.g., may communicate with one or more of the devices or systems described above with respect to FIG. 10, such as AMF 915 and/or UPF 1005) and/or some other device or system such as MEC 914. In the uplink direction (e.g., for traffic from UEs 901 to a core network), CU 1105 may aggregate traffic from DUs 1103, and forward the aggregated traffic to the core network. In some embodiments, CU 1105 may receive traffic according to a given protocol (e.g., Radio Link Control ("RLC") traffic) from DUs 1103, and may perform higher-layer processing (e.g., may aggregate/process RLC packets and generate Packet Data Convergence Protocol ("PDCP") packets based on the RLC packets) on the traffic received from DUs 1103.

CU 1105 may receive downlink traffic (e.g., traffic from the core network, traffic from a given MEC 914, etc.) for a particular UE 901, and may determine which DU(s) 1103 should receive the downlink traffic. DU 1103 may include one or more devices that transmit traffic between a core network (e.g., via CU 1105) and UE 901 (e.g., via a respective RU 1101). DU 1103 may, for example, receive traffic from RU 1101 at a first layer (e.g., physical ("PHY") layer traffic, or lower PHY layer traffic), and may process/aggregate the traffic to a second layer (e.g., upper PHY and/or RLC). DU 1103 may receive traffic from CU 1105 at the second layer, may process the traffic to the first layer, and provide the processed traffic to a respective RU 1101 for transmission to UE 901.

RU 1101 may include hardware circuitry (e.g., one or more RF transceivers, antennas, radios, and/or other suitable hardware) to communicate wirelessly (e.g., via an RF interface) with one or more UEs 901, one or more other DUs 1103 (e.g., via RUs 1101 associated with DUs 1103), and/or any other suitable type of device. In the uplink direction, RU 1101 may receive traffic from UE 901 and/or another DU 1103 via the RF interface and may provide the traffic to DU 1103. In the downlink direction, RU 1101 may receive traffic from DU 1103, and may provide the traffic to UE 901 and/or another DU 1103.

One or more elements of RAN environment 1100 may, in some embodiments, be communicatively coupled to one or more MECs 914. For example, DU 1103-1 may be communicatively coupled to MEC 914-1, DU 1103-M may be communicatively coupled to MEC 914-N, CU 1105 may be communicatively coupled to MEC 914-2, and so on. MECs 914 may include hardware resources (e.g., configurable or provisionable hardware resources) that may be configured to provide services and/or otherwise process traffic to and/or from UE 901, via a respective RU 1101.

For example, DU 1103-1 may route some traffic, from UE 901, to MEC 914-1 instead of to a core network via CU 1105. MEC 914-1 may process the traffic, perform one or more computations based on the received traffic, and may provide traffic to UE 901 via RU 1101-1. As discussed above, MEC 914 may include, and/or may implement, some or all of the functionality described above with respect to UPF 1005, AF 930, and/or one or more other devices, systems, VNFs, CNFs, etc. In this manner, ultra-low latency services may be provided to UE 901, as traffic does not need to traverse DU 1103, CU 1105, links between DU 1103 and CU 1105, and an intervening backhaul network between RAN environment 1100 and the core network.

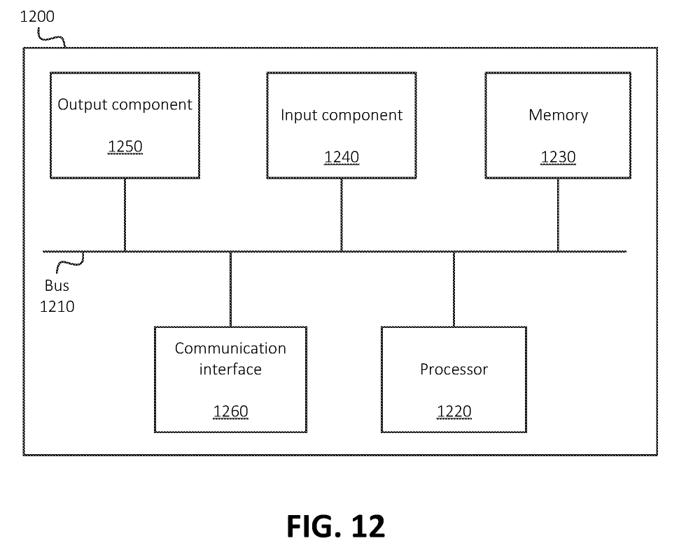

FIG. 12 illustrates example components of device 1200. One or more of the devices described above may include one or more devices 1200. Device 1200 may include bus 1210, processor 1220, memory 1230, input component 1240, output component 1250, and communication interface 1260. In another implementation, device 1200 may include additional, fewer, different, or differently arranged components.

Bus 1210 may include one or more communication paths that permit communication among the components of device 1200. Processor 1220 may include a processor, microprocessor, a set of provisioned hardware resources of a cloud computing system, a graphics processing unit ("GPU"), a GPU-based processing unit, a neural processing unit ("NPU"), or other suitable type of hardware that interprets and/or executes instructions (e.g., processor-executable instructions). In some embodiments, processor 1220 may be or may include one or more hardware processors. Memory 1230 may include any type of dynamic storage device that may store information and instructions for execution by processor 1220, and/or any type of non-volatile storage device that may store information for use by processor 1220.

Input component 1240 may include a mechanism that permits an operator to input information to device 1200 and/or other receives or detects input from a source external to input component 1240, such as a touchpad, a touchscreen, a keyboard, a keypad, a button, a switch, a microphone or other audio input component, etc. In some embodiments, input component 1240 may include, or may be communicatively coupled to, one or more sensors, such as a motion sensor (e.g., which may be or may include a gyroscope, accelerometer, or the like), a location sensor (e.g., a Global Positioning System ("GPS")-based location sensor or some other suitable type of location sensor or location determination component), a thermometer, a barometer, and/or some other type of sensor. Output component 1250 may include a mechanism that outputs information to the operator, such as a display, a speaker, one or more light emitting diodes ("LEDs"), etc.

Communication interface 1260 may include any transceiver-like mechanism that enables device 1200 to communicate with other devices and/or systems (e.g., via RAN 910, RAN 912, DN 950, etc.). For example, communication interface 1260 may include an Ethernet interface, an optical interface, a coaxial interface, or the like. Communication interface 1260 may include a wireless communication device, such as an infrared ("IR") receiver, a Bluetooth^{®} radio, or the like. The wireless communication device may be coupled to an external device, such as a cellular radio, a remote control, a wireless keyboard, a mobile telephone, etc. In some embodiments, device 1200 may include more than one communication interface 1260. For instance, device 1200 may include an optical interface, a wireless interface, an Ethernet interface, and/or one or more other interfaces.

Device 1200 may perform certain operations relating to one or more processes described above. Device 1200 may perform these operations in response to processor 1220 executing instructions, such as software instructions, processor-executable instructions, etc. stored in a computer-readable medium, such as memory 1230. A computer-readable medium may be defined as a non-transitory memory device. A memory device may include space within a single physical memory device or spread across multiple physical memory devices. The instructions may be read into memory 1230 from another computer-readable medium or from another device. The instructions stored in memory 1230 may be processor-executable instructions that cause processor 1220 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-3, 4A-4C, and 5-8), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set. Concepts described above may be embodied by, for example, a device, devices, a system, systems, a method, methods, a non-transitory computer-readable medium, and/or non-transitory computer-readable media, as provided for in the claims.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known "opt-in" or "opt-out" processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term "and," as used herein, does not necessarily preclude the interpretation that the phrase "and/or" was intended in that instance. Similarly, an instance of the use of the term "or," as used herein, does not necessarily preclude the interpretation that the phrase "and/or" was intended in that instance. Also, as used herein, the article "a" is intended to include one or more items, and may be used interchangeably with the phrase "one or more." Where only one item is intended, the terms "one," "single," "only," or similar language is used. Further, the phrase "based on" is intended to mean "based, at least in part, on" unless explicitly stated otherwise.

What is claimed is:

1. A device, comprising:
one or more processors configured to:
maintain a set of discovery retry parameters associated with a Network Function ("NF") of a wireless network;
receive a discovery request that is associated with the NF;
determine, based on receiving the discovery request, that an operational state of the NF is a first operational state out of a plurality of operational states;
identify that the set of discovery retry parameters indicates a quantity of discovery attempts to perform when determining that the NF is in the first operational state; and
perform one or more discovery retry attempts based on the set of discovery retry parameters.

2. The device of claim 1, wherein a quantity of the one or more discovery retry attempts is based on the quantity of discovery attempts indicated in the discovery retry parameters.

3. The device of claim 1, wherein the one or more processors are further configured to:
output a discovery response that includes at least one of:
discovery information associated with the NF when the one or more discovery retry attempts include determining that the operational state of NF is a second operational state of the plurality of operational states, or
an indication that the operational state of the NF is the first operational state, when the one or more discovery attempts include determining that the operational state of the NF is in the first operational state.

4. The device of claim 3, wherein the discovery information includes at least one of:
availability information associated with the NF, or
performance information associated with the NF.

5. The device of claim 1, wherein the NF is associated with at least a first instance of the NF and a second instance of the NF, wherein set of discovery retry parameters further specifies the second instance of the NF, wherein performing the one or more discovery retry attempts includes performing the quantity of discovery retry attempts indicated in the set of discovery retry parameters, wherein the one or more processors are further configured to:
determine an operational state of the second instance of the NF based on determining that the first instance of the NF is in the first operational state after performing the quantity of discovery retry attempts indicated in the set of discovery retry parameters.

6. The device of claim 1, wherein the NF is a first NF, wherein the set of discovery retry parameters is a first a set of discovery retry parameters associated with the first NF, wherein the one or more processors are further configured to:
maintain a second set of discovery retry parameters associated with a second NF of the wireless network;
identify that the discovery request is further associated with the first NF; and
select, based on identifying the discovery request is associated with the first NF, the first set of discovery retry parameters to use when performing the one or more discovery retry attempts.

7. The device of claim 6, wherein the discovery request is a first discovery request, wherein the quantity of discovery attempts is a first quantity of discovery attempts, wherein the one or more processors are further configured to:
receive, from the second NF, a second discovery request that is associated with the first NF;
determine, based on the second discovery request, that the operational state of the first NF is the first operational state;
identify that the second set of discovery retry parameters indicates a second quantity of discovery attempts to perform when determining that the first NF is in the first operational state; and
perform up to the second quantity of discovery retry attempts after determining, based on the second discovery request, that the operational state of the first NF is the first operational state.

8. A non-transitory computer-readable medium, storing a plurality of processor-executable instructions to:
maintain a set of discovery retry parameters associated with a Network Function ("NF") of a wireless network;
receive a discovery request that is associated with the NF;
determine, based on receiving the discovery request, that an operational state of the NF is a first operational state out of a plurality of operational states;
identify that the set of discovery retry parameters indicates a quantity of discovery attempts to perform when determining that the NF is in the first operational state; and
perform one or more discovery retry attempts based on the set of discovery retry parameters.

9. The non-transitory computer-readable medium of claim 8, wherein a quantity of the one or more discovery retry attempts is based on the quantity of discovery attempts indicated in the discovery retry parameters.

10. The non-transitory computer-readable medium of claim 8, wherein the plurality of processor-executable instructions further include processor-executable instructions to:
output a discovery response that includes at least one of:
discovery information associated with the NF when the one or more discovery retry attempts include determining that the operational state of NF is a second operational state of the plurality of operational states, or
an indication that the operational state of the NF is the first operational state, when the one or more discovery attempts include determining that the operational state of the NF is in the first operational state.

11. The non-transitory computer-readable medium of claim 10, wherein the discovery information includes at least one of:
availability information associated with the NF, or
performance information associated with the NF.

12. The non-transitory computer-readable medium of claim 8, wherein the NF is associated with at least a first instance of the NF and a second instance of the NF, wherein set of discovery retry parameters further specifies the second instance of the NF, wherein performing the one or more discovery retry attempts includes performing the quantity of discovery retry attempts indicated in the set of discovery retry parameters, wherein the plurality of processor-executable instructions further include processor-executable instructions to:
determine an operational state of the second instance of the NF based on determining that the first instance of the NF is in the first operational state after performing the quantity of discovery retry attempts indicated in the set of discovery retry parameters.

13. The non-transitory computer-readable medium of claim 8, wherein the NF is a first NF, wherein the set of discovery retry parameters is a first a set of discovery retry parameters associated with the first NF, wherein the plurality of processor-executable instructions further include processor-executable instructions to:
maintain a second set of discovery retry parameters associated with a second NF of the wireless network;
identify that the discovery request is further associated with the first NF; and
select, based on identifying the discovery request is associated with the first NF, the first set of discovery retry parameters to use when performing the one or more discovery retry attempts.

14. The non-transitory computer-readable medium of claim 13, wherein the discovery request is a first discovery request, wherein the quantity of discovery attempts is a first quantity of discovery attempts, wherein the plurality of processor-executable instructions further include processor-executable instructions to:
receive, from the second NF, a second discovery request that is associated with the first NF;
determine, based on the second discovery request, that the operational state of the first NF is the first operational state;
identify that the second set of discovery retry parameters indicates a second quantity of discovery attempts to perform when determining that the first NF is in the first operational state; and
perform up to the second quantity of discovery retry attempts after determining, based on the second discovery request, that the operational state of the first NF is the first operational state.

15. A method, comprising:
maintaining a set of discovery retry parameters associated with a Network Function ("NF") of a wireless network;
receiving a discovery request that is associated with the NF;
determining, based on receiving the discovery request, that an operational state of the NF is a first operational state out of a plurality of operational states;
identifying that the set of discovery retry parameters indicates a quantity of discovery attempts to perform when determining that the NF is in the first operational state; and
performing one or more discovery retry attempts based on the set of discovery retry parameters.

16. The method of claim 15, wherein a quantity of the one or more discovery retry attempts is based on the quantity of discovery attempts indicated in the discovery retry parameters.

17. The method of claim 15, further comprising:
outputting a discovery response that includes at least one of:
discovery information associated with the NF when the one or more discovery retry attempts include determining that the operational state of NF is a second operational state of the plurality of operational states, wherein the discovery information includes at least one of availability information associated with the NF, or performance information associated with the NF, or
an indication that the operational state of the NF is the first operational state, when the one or more discovery attempts include determining that the operational state of the NF is in the first operational state.

18. The method of claim 15, wherein the NF is associated with at least a first instance of the NF and a second instance of the NF, wherein set of discovery retry parameters further specifies the second instance of the NF, wherein performing the one or more discovery retry attempts includes performing the quantity of discovery retry attempts indicated in the set of discovery retry parameters, wherein the method further comprises:
determining an operational state of the second instance of the NF based on determining that the first instance of the NF is in the first operational state after performing the quantity of discovery retry attempts indicated in the set of discovery retry parameters.

19. The method of claim 15, wherein the NF is a first NF, wherein the set of discovery retry parameters is a first a set of discovery retry parameters associated with the first NF, wherein the method further comprises:
maintaining a second set of discovery retry parameters associated with a second NF of the wireless network;
identifying that the discovery request is further associated with the first NF; and
selecting, based on identifying the discovery request is associated with the first NF, the first set of discovery retry parameters to use when performing the one or more discovery retry attempts.

20. The method of claim 19, wherein the discovery request is a first discovery request, wherein the quantity of discovery attempts is a first quantity of discovery attempts, wherein the method further comprises:
receiving, from the second NF, a second discovery request that is associated with the first NF;
determining, based on the second discovery request, that the operational state of the first NF is the first operational state;
identifying that the second set of discovery retry parameters indicates a second quantity of discovery attempts to perform when determining that the first NF is in the first operational state; and
performing up to the second quantity of discovery retry attempts after determining, based on the second discovery request, that the operational state of the first NF is the first operational state.
